(19) United States
(12) Patent Application Publication
(10) Pub. No.: US 2014/0129556 A1
(43) Pub. Date: May 8, 2014

(54) SYSTEM AND METHOD FOR RECEIVING, STORING, MANIPULATING AND DISTRIBUTING RF DIGITAL INFORMATION FILES

(71) Applicant: QRC, Inc.dba QRC Technologies, Fredericksburg, VA (US)

(72) Inventor: Thomas F. Callahan, Spotsylvania, VA (US)

(73) Assignee: QRC, Inc. dba QRC Technologies, Fredericksburg, VA (US)

(21) Appl. No.: 14/072,269

(22) Filed: Nov. 5, 2013

Related U.S. Application Data
(60) Provisional application No. 61/723,109, filed on Nov. 6, 2012.

(51) Int. Cl. G06F 17/30

(52) U.S. Cl. CPC G06F 17/30386
USPC 707/736

(57) ABSTRACT

A system and method for receiving storing, manipulating and distributing RF data. A computing device receives and stores collected RF data. A requesting user issues a request for the RF data file, which request includes one or more modification parameters. The computing device selects one or more processing algorithms based on the one or more modification parameters and applies the selected processing algorithms to the collected RF data. The computing device provides the manipulated RF data to the requesting party in response to the request.

### CROSS REFERENCE TO RELATED APPLICATIONS

This application claims the benefit of priority to U.S. Provisional Application No. 61/723,109 filed on Nov. 6, 2012, the contents of which is hereby incorporated by reference for all purposes.

### BACKGROUND

Using systems comprised of a RF tuning circuit, possible down converter, and digitizer (A/D) and other devices it is possible to generate files known as RF Digital Information (RDI) files that contain a digital representation of RF signal information.

RDI files may be collected by a number of different users who require such information. While this information may be stored, the records may be maintained in any number of formats that are not necessarily standard from one user to another. Further, users who are in different organizations may require RDI files that are collected in common areas of interest geographically and over common frequency ranges.

### SUMMARY

A system and method that allows users to know that collected RDI information exists is illustrated herein. In addition, in various embodiments, companies and various organizations have capabilities to collect RDI files but may not have specific tasking to do so can be leveraged to provide useful RDI files. In various embodiments, RDI collectors are incentivized to collect RDI files having commercial value when that information may be useful to a number of individuals, even if that information is not required from the specific entity performing the collection services.

Embodiments illustrated herein are directed to creating and managing of RDI files.

In an embodiment, a hosted internet accessible service (website) provides users the ability to register for an account with pertinent profile information and then share RDI files with other users of the system.

In another embodiment, systems and/or methods provide a user the ability to find, via searching and/or cataloging, RDI files of interest.

In still another embodiment, systems and/or methods provide a user the ability to manipulate existing RDI files as well as new RDI files that are uploaded to the system to produce “Manipulated RF Digital Information” or “MDI” files.

In yet another embodiment, systems and/or methods establish a “market” for RDI files and tasking. The RDI market allows a user to request collection of, or access to, RDI files of interest by notifying other users of this potential tasking. Users having the capability to obtain RDI files may then “bid” on the collection of such information that is desired by a user who may then contract with the collecting user for that information. Upon acceptance by an interested user, the collecting user can collect and provide a new RDI file to the system which may then be disseminated only to the interested user. Thereafter, the file may remain in the system for subscription or licensing by other interested users.

In an embodiment, systems and/or methods that provide ability of the system to “loan” or “license” RDI files from the system for a specific period of time to a specific user or multiple users. In this embodiment, the system can update its catalog and “push” notifications relating to new RDI collections to interested users.

In an embodiment, RF data is received, stored, manipulated and distributed. A computing device receives first collected RF data, stores the first collected RF data in a storage device, receives a request for the first collected RF data, which request comprises one or more modification parameters, selects one or more processing algorithms based on the one or more modification parameters, applies the selected one or more processing algorithms to the first collected RF data, and provides the manipulated RF data in response to the request.

In an embodiment, the manipulated RF data may be provided via a network. In another embodiment, the computing device may authorize the delivery of the manipulated RF data on a tangible medium.

By way of illustration and not by way of limitation, the modification parameters may be selected from the group consisting of a filter specification, a noise type, and a multipath specification.

By way of illustration and not by way of limitation, the processing algorithms may be selected from the group consisting of a frequency shifting, selection of bandwidth, application of a specific filter type, decimating, duration subsets (different start and/or end point), sample counts, noise addition/subtraction, a multi-path simulation, a power level adjustments, and an output format translation.

In an embodiment, the computing device may store the manipulated RF data in the storage device and apply the modification parameters to the manipulated RF data.

In still another embodiment, first and second collected RF data are received by the computing device. In this embodiment, the request at least includes a modification parameter to combine the first collected data with the second collected data.

### DESCRIPTION OF THE DRAWINGS

FIG. 1 is a block diagram illustrating a RF digital recorder and playback system according to an embodiment.

FIG. 2 is a flow diagram illustrating a process for obtaining RDI files according to an embodiment.

FIG. 3 is a block diagram illustrating a system architecture according to an embodiment.

FIG. 4 is a block diagram illustrating components of a server device useful for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term RF Digital Information (RDI) file is a file or record in any format that includes a digital representation of RF signal information. An RDI file may also include “meta data” that specifies pertinent information about the file's construction. In an embodiment, an RDI file includes an in phase amplitude measurement of a signal (I) and a 90° phase-shifted amplitude measurement of the signal (Q).

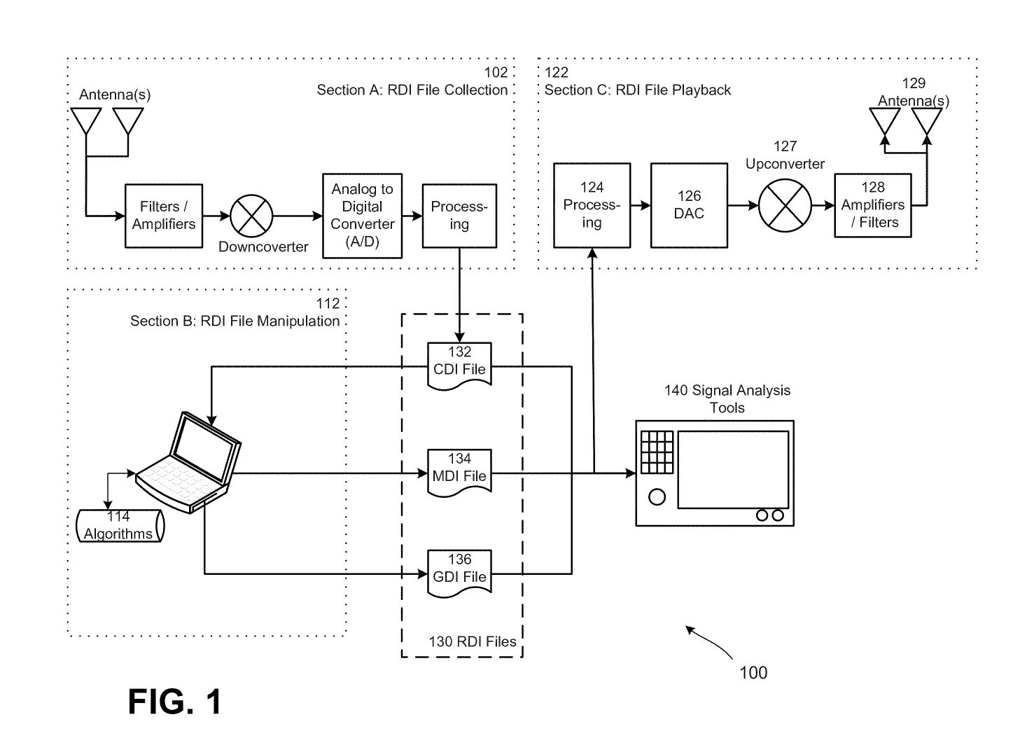

FIG. 1 illustrates a block diagram of an RF digital recorder and playback system 100. The system 100 includes a RDI file collection section 102, an RDI file manipulation section 112, an RDI file playback section 122 and signal analysis tools 140. Stored RDI files 130 may be shared amongst multiple users. Collected data is stored as a specified type of RDI file, known as a CDI file 132. CDI files are a specified type of RDI where the source is known to be direct digital collection of RF spectrum without modification. CDI Files are generally the same in the format as other RFI file types, with the distinction being for ease of discussing how the file came into existence. Additionally, the CDI files 132 may be manipulated using the RDI file manipulation section 112 in numerous ways based on well-established signal processing algorithms 114 to produce a new file or files each of which is different but similar to the original source file. The output of the CDI file manipulation section 112 are represented as a “Manipulated RF Digital Information” file or “MDI” file 134. MDI files are a specified type of RDI where the source is known to be modified RF spectrum information. MDI Files are generally the same in the format as other RDI file types, with the distinction being for ease of discussing how the file came into existence. An MDI file 134 may also be manipulated to produce other MDI files. Additionally, files can be generated using other tools without needing to first collect over-the-air information. As illustrated in FIG. 1, a generated file is represented as a “Generated RF Digital Information file or “GDI” file 136. GDI files are a specified type of RDI where the source is known to be computer generated/simulated RF spectrum information. GDI Files are generally the same in the format as other RDI file types, with the distinction being for ease of discussing how the file came into existence. All of the RDI file types defined may also be manipulated to produce an MDI file.

An RDI file 130 may be played back using the RDI file playback section 122. As illustrated, the RDI file playback section 122 may include signal processing 124, a digital-to-analog converter (DAC) 126, an up-converter 127, amplifiers/filters 128 and a transmission system 129. RDI files of any type (recorded, generated, and manipulated) can be transmitted at original collected or intended frequency, or alternate frequency (referred as an “intermediate frequency”, or IF) based on the intended use, as shown in RDI file playback section 122. In addition to playback, RDI Files can be fed into other analysis tools 140 for multiple additional uses including mathematical analysis and simulation.

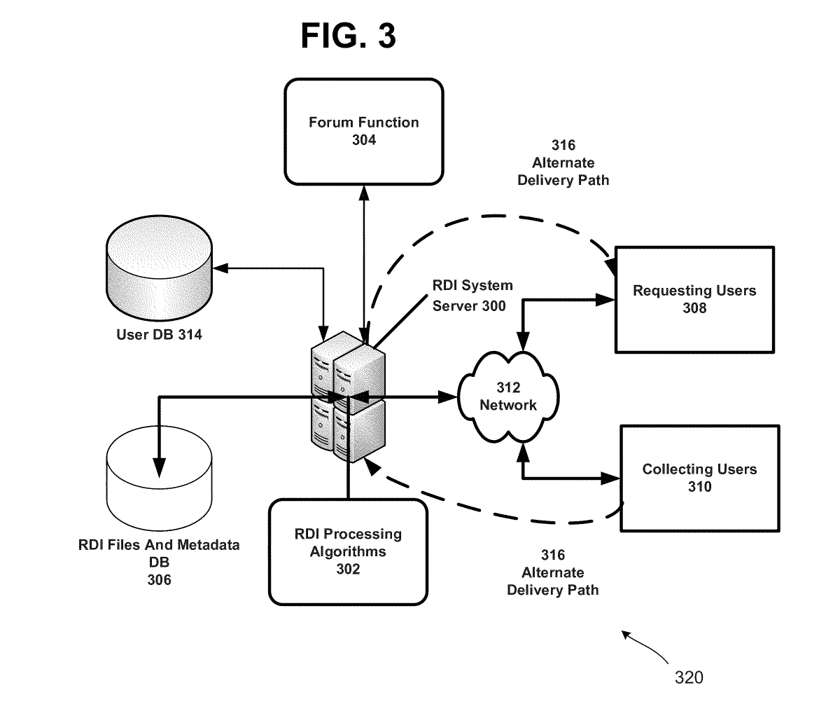

Various embodiments illustrated herein give rise to an RDI exchange system 320 illustrated in FIG. 3. In an embodiment, an RDI system server 300 manages the functionality of the overall system. This functionality involves registering different user types and their profiles. For example requesting users 308 will interact with the RDI system server 300 over a network 312, for example but without limitation, the Internet. Other types of networks may also be used including cellular networks, satellite networks and any other network commonly used for interchanging and interacting between a server and its users.

The RDI system server 300 accepts applications and registers users and stores information in a user database, 314. This information contains the profile of users requesting information (“requesting users”) 308 and profiles of those who are willing to collect the necessary RDI information (“collecting users”) 310.

In the case of requesting users, 308, the identity and interest areas for RDI information are listed together with the individual user identities. In a similar fashion, the profiles of the collecting users 310, are also registered together with their identifying information and information concerning their collection capabilities, equipment, processing, geographic area, and other factors of interest. A single person may be registered as both a requesting and generating user, in which case information is stored for both roles into a single user account.

Each user account may include pertinent profile information and security controls on the accounts to control access to the user account. Optionally, multiple user accounts may be associated with one organization that has an organization administrator. As will be discussed below, the RDI exchange system 320 may facilitate the exchange of RDI files for payment. In this embodiment, an account or organization profile may include information necessary to pay for RDI files that are received. Additionally, for collecting users, a profile may include information necessary to receive payment for RDI files that are submitted.

The profile of a collecting user or organization may further include location(s) where the collecting user is able to collect RDI files and the type of equipment available to collect and/or generate RDI files.

In an embodiment, collecting user database 314 may also maintain statistics on the collecting user's submissions/retrievals for rankings and marketing purposes.

In an embodiment, the RDI system server 300 also manages a fourm function, 304, that permits those users who are registered in the user database 314, to interact with one another for various purposes further described below.

Embodiments illustrated herein further provide the ability to manage and store RDI files in the RDI files database 306. A collecting user may directly upload RDI files via a network, such as, for example, the Internet. Other types of networks may also be used including cellular networks, satellite networks and any other network commonly used for interchanging and interacting between a server and its users. A collecting user may also register with the operator of the RDI exchange system 320 to provide file(s) to the system manager on any common media type (CD, DVD, USB Drive, CF, SD, etc.).

The RDI exchange system 320 may notify interested users, typically requesting users, that the submitted RDI files have been received and stored in the RDI files database 306. In an embodiment, an RDI file may include meta data. By way of illustration and not by way of limitation, metadata may include:
a description of the file in a searchable text format;
the location(s) and time(s)/date(s) the RDI file was collected or generated;
the frequenc(ies) associated with the collected the RDI file;
the bandwidth(s) of the collected the RDI file(s);
a suggested demonstration/validation method, including disallowing verification (described below);
physical setup information pertinent to the RDI file (e.g., the generating source(s) for collection, use of preamplifiers, modeling tool used to generate, etc.) for CDI files;
a list of user accounts who submitted original RDI file(s);
a history of any modifications to stored RDI files as well as the users who have modified the file in the system in the creation of any derived RDI file;
the base or recommended price of using the file as set by each user who has been involved in creating the RDI file should it be retrieved;
information on modifications to a source file(s) to create a MDI file;
cost information associated with a user obtaining the file, including cost history if one exists
links to other RDI file(s) in the system that is similar or relevant to the file;
links to an auction that generated this file (if generated by auction);
access restrictions on the file to specific system users (if desired);
additional terms and conditions unique to this file beyond typical system terms and conditions; and
reviews of this file by other user(s) in the system.

In an embodiment, a collecting user may delete an RDI file or its metadata stored in RDI database 306 or may modify the RDI file or its associated metadata in order to update any of the fields described and/or listed herein, change the pricing of, or other terms associated with the RDI file sale or licensing, or link the file to other RDI file(s) in the RDI database 306.

The RDI system server 300 also comprises a series of processing algorithms 302, whereby RDI files may be modified based upon request by requesting users 308. When a user requests modifications of files, the request is received by the RDI system server 300 together with the request for the appropriate desired processing (if any such processing is needed or desired). The RDI system server 300 extracts the appropriate RDI file from the RDI file database 306 and applies the appropriate processing algorithm from its library 302 and returns the processed data over the network 312 to the requesting user 308 or via an alternate delivery path 316. The resultant MDI file is also returned to the RDI file database 306 where it is stored together with metadata concerning the processing that has occurred for that specific RDI file. In this fashion a requesting user can determine if processing of a particular kind has already been applied to an RDI file which may (or may not) meet the needs of the particular requesting user.

All commercial operations are also managed by the RDI system server including applying appropriate terms and notifying requesting users of the terms that are applied to the RDI files from the RDI file database 306. The RDI system server 300 also interacts with the requesting users and collecting users to process payment from which requesting users 308 and distribute payment to collecting users 310. In an embodiment, the RDI system server 300 may to issue “retrieval” credits to collecting users 310 for submitted files, which credits may be used as a system credit for retrievals by the collecting user (acting as a requesting user) from the RDI exchange system 320.

The various embodiments illustrated herein also have the ability to analyze a stored RDI file and generate associated meta information including those items described and/or listed herein.

The RDI exchange system 320 also provides users the ability to search for files of interest by any combination of the fields described and/or listed herein.

The system of the various embodiments herein may also recommend “other files” to users based on items such as search parameters used, paid promotional considerations, or other similar characteristics to the file being view.

Once a requesting user makes a decision to obtain a particular RDI file(s), the requesting user may retrieve those files by a number of methods including but without limitation direct download of the RDI files over a network 312, or storage on a common media type (CD, DVD, USB Drive, CF, SD, etc.) for shipment to a location chosen by the user over the alternate delivery path 316.

Once a decision by the requesting user is made and the file is to be retrieved, the system has the ability to charge and collect a fee for retrieval of a file of interest. It is anticipated that the commercially implemented system will collect fees for the RDI files retrieved by the requesting user and disburse payment to the collecting users for use of their RDI files.

In an embodiment, a forum function 304 is provided by the RDI system server 300. The forum function 304 allows a requesting user 308 to request a specific RDI file that does not already in existence in the RDI file database 306. One or more collecting users 310 may offer to satisfy that request and provide a file of interest subject to agreement on terms of usage and financial compensation. In this fashion, requests can then be made over the RDI exchange system 320 for access to the desired RDI files. Requests may include any or all of the following but without limitation:
location of RDI file data;
frequency(ies) RDI file data;
bandwidth RDI file data;
duration of RDI file data;
waveform/Content of the RDI file data; and
date(s) of the RDI file data.

In an embodiment, a requesting user may verify the content of an RDI file before retrieving it. By way of illustration and not by way of limitation, a file may be viewed using a visualization application, by obtaining the file on short term basis for verification purposes only, by receiving a file that is configured only for partial file playback, and by receiving a file in which some aspects of collected data (e.g., intentional discontinuity, added noise, etc.) are intentionally corrupted to limit the utility of the RDI file during a requesting user evaluation.

The various embodiments illustrated herein allow RF digital information to be collected from signal generators or other artificial generator sources and stored in a central database. The system also provides for the tagging of RDI files with pertinent meta data including location(s) the data was collected/generated, date(s) the data was collected/generated, frequency(ies) the file was collected/generated at, bandwidth(s) used in the collection/generation, the physical setup of the generation/collection and other useful information in making use of the file. This tagging facilitates the searching of the system library for the RDI files of interest to a user. This tagging function also allows the system to make recommendations to a user concerning RDI files that may be of interest to that user based upon user search characteristics. Further, in the event that certain “promotions” are desirable, these promotions can be “pushed” to those users having appropriate user profiles.

In an embodiment, a requesting user may instruct the RDI exchange system 320 to perform processing on a requested file or on requested files using algorithms 302. In this embodiment, the processing on existing RDI files creates a new MDI or GDI type RDI files based upon user's request. By way of illustration and not by way of limitation, processing may include:
frequency shifting;
basic filtering (selection of a smaller bandwidth of an existing file);
advanced filtering (application of specific filter types to the file);
decimating;
duration subsets (different start and/or end point) of a file to make a smaller derived efforts;
precise sample counts (a specific number of samples from the start point, generally to assure a specific periodicity of the resultant file);
noise addition/subtraction;
multi-path simulation;
file combination (combining multiple RDI files into a new file);
power level adjustments; and
output format (RDI file format) translations.

The operations noted above can be applied in a combination of operations in any order on a source or derived RDI file using the exemplary algorithms described herein. Based on the operations executed on the RDI files, the RDI system server 300 may modify the file cost or charge a processing fee based upon the operations desired by the requesting user.

The operation of the RDI exchange system 320 made be further illustrated by reference to an example of a user interaction with the RDI exchange system 320.

A collecting user 1 (CU 1) uploads an RDI file collected in Herndon, Va. The file includes 25 MHz of recorded spectrum centered at 1942.5 MHz The spectrum sample thus spans a spectral segment from 1930 MHz to 1955 MHz The spectral segment includes CDMA (region: 1930 MHz-1935 MHz), LTE (1935 MHz-1945 MHz), as well as GSM (1945-1950), and WCDMA (1950-1955 MHz). The uploaded RDI file is made available to anyone by CU 1.

A requesting user (RU 1), is interested in LTE signals at the Herndon location. RU 1 requests CU 1's file and instructs the RDI exchange system 320 to apply 10 MHz FIR Filter to it centered at 1940 MHz The RDI exchange system 320 selects the appropriate filter from RDI processing algorithms 302 and generates an MDI file 1. RU 1 makes the new MDI file 1 available to others.

Another requesting user (RU 2) is interested in the effects of noise on an LTE signal. RU 2 searches RDI files database 306 and selects MDI file 1 and instructs the RDI exchange system 320 to add Gaussian white noise to the signal of MDI file 1. The RDI exchange system 320 selects the appropriate algorithm from RDI processing algorithms 302 and generates an MDI file 2. RU 2 makes the new MDI file 2 available to others.

Another requesting user (RU 3) is interested in the effects of multipath in a real world environment for LTE Signals. RU 3 searches RDI files database 306 and selects both MDI file 1 and MDI file 2 as being of interest. The signal in MDI file 1 includes noise because it was “recorded from the air.” RU 3 starts with that MDI file 1. RU 3 decides to simulate a denser area and instructs the RDI exchange system 320 to add to MDI file 1 the content of MDI file 1 delayed by ˜120 meters and 10 times weaker than the original MDI 1 signal. RDI system server 300 analyzes MDI file 1 and determines that the request is satisfied by a 10-sample shift. A temporary file (MDI file 1.1) is created that has the first 10 samples blank (0), then the rest of the content values divided by 10. MDI file 1.1 is added to MDI file 1 by the RDI system server 300 to make a new temporary working file MDI file 1.2.

RU 3 requests that MDI file 1.2 be further modified to use MDI file 2 that reflects the noise profile created by RU2 to add a multipath component that is delayed by 60 meters and is half the power. RU 3 instructs the RDI exchange system 320 to modify MDI file 2 accordingly and to add the modified MDI file 2 to temporary working file MDI 1.2.

RDI system server 300 analyzes MDI file 2 and determines that the request is satisfied by applying a 5-sample shift. A temporary MDI file 3.1 is created that has the first 5 samples blank (0), then the rest of the content values from File 3 divided by 2. Temporary MDI file 3.1 is added to temporary working file MDI file 1.2 to produce MDI file 1.2.1.

RU 3 views MDI file 1.2.1 and is satisfied that it has the requested. In an embodiment, RU 3 requests that a physical media containing MDI file 1.2.1 be sent to his location via alternative delivery path 316 because the size of the file is too large to download from the system via the network 312.

In an embodiment, the user-requested processing may include modeling of an RDI file or files within the system to allow a user to inspect a RDI file. By way of illustration and not by way of limitation, the RDI exchange system 320 may support common signal visualization tools including:
spectrum (power spectral density plot) of the signal;
waterfall of the spectrum of a signal;
time domain representation of the signal; and
IQ of the signal (or subset of the signal).

The RDI system server 300 also comprises instructions that allow the processor to group RDI files into RDI file bundles that can be retrieved as a set at a price that may be independently set or apply an algorithm on the cost of the files that make up the file set. This pricing capability also allows the RDI system server 300 to manage a subscription to bundles of files (which may include ALL files) during which the user may retrieve any of the files in the associated bundle for a prearranged fee or fee formula.

As an example of the financial flexibility associated with the RDI system server 300, the various embodiments illustrated herein provide for the ability to license desired or requested RDI files for use on specific supporting equipment to include (but without limitation) the following license terms:
period of use (start date to end date) during with the equipment will permit use of the file for playback;
duration of use (amount of time from first use) during with the equipment will permit use of the file for playback; and
quantity of use (amount of times the file may be used) during with the equipment will permit use of the file for playback.

Other licensing terms that may be administrated by the RDI system server 300 include but are not limited to the following:
use only on a specific system or set of systems (by serial number of approved equipment);
use only a specific type of system or tool; and
the ability to support direct submittal, search, and retrieval of RDI file store data by a recording, playback or analysis system via associated user accounts.

In an embodiment, the RDI exchange system 320 may support additional commercial functions. By way of illustration and not by way of limitation, the RDI exchange system 320 may support:
the ability to support a volume discounting policy;
the ability to authorize discounts where requesting users of RDI files are charged preferential rates when they are frequent purchasers of RDI files or users of the additional processing functionality of the system; and
the ability to provide discount credits that may expire over time or which are offered to encourage users to make additional purchases.

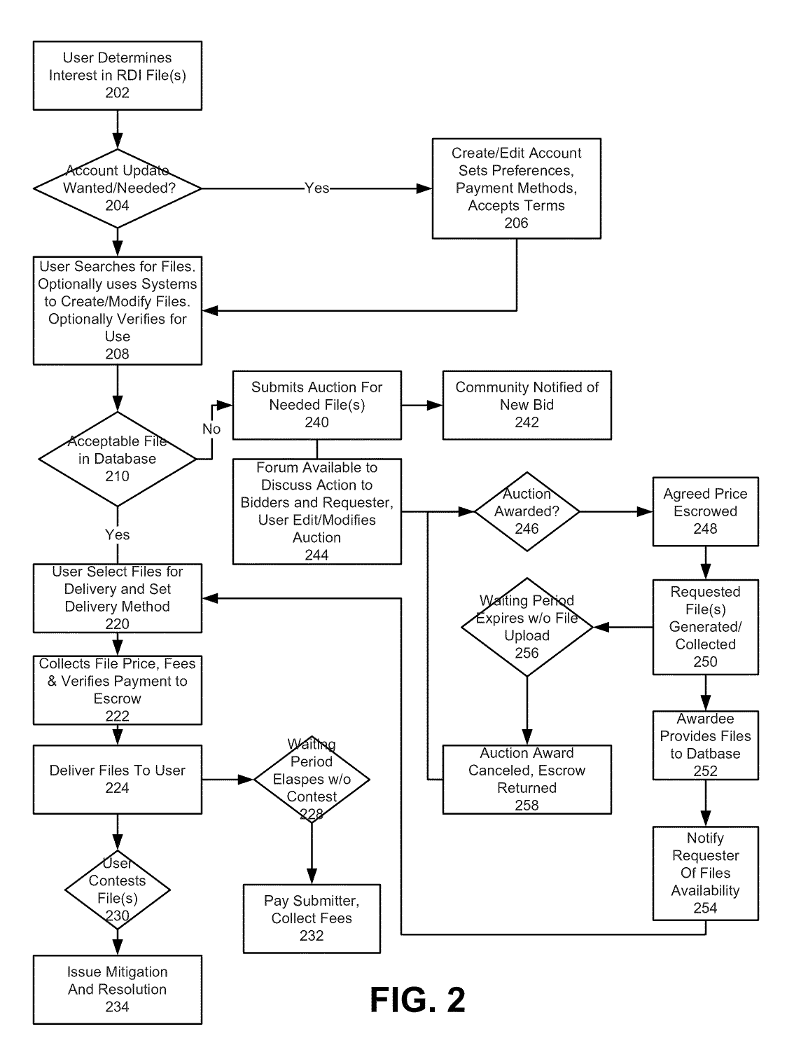

Referring now to FIG. 2, a commercial implementation of an RDI market is illustrated. A requesting user initially identifies the need for RDI files (Block 202).

If the requesting user has an account, he or she may log in. If the requesting user does not have an account, he or she may create an account (Block 204). The system or requesting user may determine whether to update the user account information (Block 206). As part of owning an account, license terms must be accepted for both downloading and uploading files and if the general terms are modified since last access the now modified terms are accepted before further access.

The requesting user searches the library for RDI files to meet a particular need, and if desired modifies existing files to suite that need and views or verifies a file of interest (Block 208).

A determination is made whether acceptable files are present in the database (Block 210). If an acceptable file is found (or created), that is, if the result of Block 210 is “YES,” the requesting user may continue to Block 220 to acquire the file or modified file.

The user interested in an RDI file, or the requesting user in case of auction results, selects the method of delivery for the files to be acquired (Block 220). Payment is collected from the interested user (Block 222), and the files are delivered for their use (Block 224).

The user has the opportunity to contest the delivered files (Block 230) at which point the issue is taken up by the service provider to contact the impacted users and resolve as the issue (Block 234). After a waiting period without contest, or upon user acceptance of the file by the downloading user, the original submitter is paid for the file and the service provider collects its fees (Block 234).

If an acceptable file is not found, that is, if the result of Block 210 is “NO,” the requesting user may elect to submit a new auction for a file of interest (Block 240) by specifying the pertinent information for a file desired.

On submission of a new auction by the requesting user, the user community is notified based on their preferences (Block 242) and a new forum thread is created corresponding to the created auction (Block 244). The requesting user may chose to remain anonymous, in which case the requesting user is assigned a temporary name to use when interacting with the system for purposes of the auction.

The requesting user may specify additional terms and conditions for the auction and resulting deliverables which must be accepted by any user submitting a bid. For example, the request for RDI information that is prepared by the requesting user may specify that only the requesting user will be permitted to use the newly acquired information. Typically, such exclusivity would carry a higher price since user submitting a bid to provide the data would not be able to derive any additional revenue from the data. If, however, the requesting user indicates that the request is for non-exclusive use of the collected data, the collection price lower since the user submitting a bid may be able to derive future revenue from licensing the collected data from the RDI system server database.

The requesting user and other users interact via a forum (Block 244) to correspond on the desired file(s), which includes the ability for the requesting user to modify the request based on clarifications or other desires.

Any user is permitted to enter bids to collect and or create the requested file(s), users submitting a bid are then known as “bidders.” If a bidder elects, they may remain anonymous, in which case they are assigned a temporary name to use when interacting with the system for purposes of this auction and for any files they provide in satisfaction of the bid should they be the awardee (i.e. the bidder submitting the winning the bid). The bidder may also specify additional terms and conditions for their bid and resulting deliverables which must be accepted by the requesting user should they accept that bid.

When the requesting user accepts a bid (Block 246), the agreed upon fee is placed into escrow (Block 248). The bidder submitting the winning the bid is now referred to as the “awardee.”

The awardee collects or generates the requested file(s) (Block 250).

The awardee provides the file(s) to the system (Block 252) and specifies them as satisfying the auction as part of the upload process. File submitters are generally able to modify the metadata for files they provide at any time after the files are in the system, which includes the ability to later remove the anonymous condition, change any terms and conditions imposed by the file provider, and modify the suggested price for future users downloading the file. The requesting user's terms and conditions are considered subservient to the awardee's terms and conditions upon award acceptance in case of conflict. However, any changes to terms and conditions by the awardee imposed after award will not apply to the requesting user but will apply to others who later access the file should it be available for general use.

The requesting user is then notified (Block 254) that the files are available.

If the waiting period expires before the awardee has uploaded files (Block 256) then the award is canceled and the award fee is returned from escrow to the requesting user (Block 258).

In an embodiment, the RDI files are stored according to a file structure that facilitates locating a file and modifying a file. The file structure described below may use the following abbreviations:

TABLE 1
Acronyms and Abbreviations

| Abbreviation | Name | Meaning |
|---|---|---|
| WBT | Wide Band Transcorder | The product that this document provides information for. |
| VRT | VITA Radio Transport | Specifically refers to VITA Radio Transport Standard 49.0, the |
| | | packet standard WBT follows. |
| QVRT | QRC VRT | The WBT's data file format, QRC's implementation of VRT |
| OUI | Organizationally Unique | A 24-bit, IEEE-assigned code that identifies the organization |
| | Identifier | producing the product that creates the data. |
| TSI | TimeStamp - Integer | The name used by the VRT specification to denote the field that |
| | | determines the type of value and whether there will be a value |
| | | shown in the Integer Timestamp field. |
| TSF | TimeStamp - Fractional | The name used by the VRT specification to denote the field that |
| | | determines the type of value and whether there will be a value |
| | | shown in the Fractional Timestamp field. |
| TSM | TimeStamp Mode | The name used by the VRT specification to denote the field that |
| | | determines whether the timestamp fields of a context packet have |
| | | fine or coarse resolution. |

### 1 About the WBT Data File Format

The requesting user is notified (Block 254) that the files are available.

WBT data file format is a binary representation of the data packets collected from the radio as augmented with information packets generated by the WBT system to provide context to the RF samples. All packets comply with the VITA-49.0 VITA Radio Transport (VRT) Standard. All data is in BIG ENDIAN format. Every packet is made up of a number of 32-bit words, specified in the packet size field in the packet's header.

### 2 Packet Header Information

All packets within the file begin with a header, which is in the following format.

TABLE 2

| | | | | | | | | | | | | | | | | | |
|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 |

| | | | | | | | | |
|---|---|---|---|---|---|---|---|---|
| Packet Type | C | T | R | TSM | TSI | TSF | Packet Count | Packet |
| | | | | | | | | Size |

| | | | | | | | | | | | | | |
|---|---|---|---|---|---|---|---|---|---|---|---|---|---|
| 13 | 12 | 11 | 10 | 9 | 8 | 7 | 6 | 5 | 4 | 3 | 2 | 1 | 0 |

Packet Size

TABLE 3

| | Bits | |
|---|---|---|
| Field Name | used | Description |
| Packet Type | 28-31 | Indicates the type of packet, see Section 2.1 |
| C | 27 | Indicates Class ID field is present. WBT does not supply this indicator. |
| T | 26 | Indicates trailer is present. See Section 3.4 |
| R | 25 | Reserved |
| TSM | 24 | Indicates that coarse timing is in use when used in a context packet. |
| TSI | 22-23 | Indicates the presence and type of Integer Timestamp Field. See Section 2.2 |
| TSF | 20-21 | Indicates the presence and type of Fractional Second Timestamp Field. See |
| | | Section 2.3 |
| Packet Count | 16-19 | Field that starts at 0 and counts up by 1 with each packet until it overflows back |
| | | to 0. |
| Packet Size | 0-15 | Indicates the number of 32-bit words that make up the packet. |

2.1 Packet Type

TABLE 4

| Packet Type | | | | |
|---|---|---|---|---|
| Value | | | | Packet Type |
| 0 | 0 | 0 | 1 | Data Packet - IF Data Packet with Stream ID, See |
| | | | | Section 5 |
| 0 | 0 | 1 | 0 | File Data - Extension Data Packet (JSON), See |
| | | | | Section 4 |
| | | | | File Header - Extension Data Packet (binary), See |
| | | | | Section Error! |
| | | | | Reference source not found. |
| 0 | 1 | 0 | 0 | GPS/Radio Data - IF Context Packet, See |
| | | | | Section [00143] |
| 0 | 1 | 0 | 1 | Future spec - Extension Context Packet, See Section 6 |

WBT uses only the above specified Packet Type Values.

2.2 TSI—TimeStamp-Integer

TABLE 5

| | |
|---|---|
| TSI Code | Meaning |

| | | |
|---|---|---|
| 0 | 0 | No Integer Seconds |
| | | Timestamp |
| 1 | 0 | GPS Time |

2.3 TSF—TimeStamp-Fractional

TABLE 6

| | |
|---|---|
| TSF Code | Meaning |

| | | |
|---|---|---|
| 0 | 0 | No Fractional Seconds |
| | | Timestamp |
| 0 | 1 | Sample Count |

### 3 Common Field Formats

3.1 Stream Identifier

The stream identifier is the first field after the header in the IF Data with Stream ID and IF Context packets.

TABLE 7

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Stream ID (0-31)

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Stream ID (0-31)

TABLE 8

| Stream ID | Radio That Serves The Stream |
|---|---|
| 1 | Radio A |
| 2 | Radio B |

The stream identified is a 32 bit number used to identify the radio the packets are related to. More streams are possible in the future, and processing software handles this situation by ignoring a stream identifier that is not recognized.

3.2 Integer Seconds Timestamp Field

The integer timestamp field is the next field in the packet and is 32 bits long, assuming that the TSI bits are set to a value other than 00.

TABLE 9

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Integer Seconds Timestamp (0-31)

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Integer Seconds Timestamp (0-31)

TABLE 10

| TSI Code | | Meaning of Integer Timestamp Field Value |
|---|---|---|
| 0 | 0 | No Integer Seconds Timestamp |
| 1 | 0 | GPS Time - If you are receiving GPS data, it should give you |
| | | the number of seconds since midnight Jan. 6, 1980, if you are |
| | | not receiving GPS the field will have the value 0. |

3.3 Fractional Seconds Timestamp Field

The fractional seconds timestamp field is the next field in the packet, assuming that the TSF bits are set to a value other than 00. It is comprised of two 32-bit words.

TABLE 11

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Fractional Seconds Timestamp (32-64)
Fractional Seconds Timestamp (0-31)

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Fractional Seconds Timestamp (32-64)
Fractional Seconds Timestamp (0-31)

TABLE 12

| TSF Code | | Meaning of Fractional Timestamp Field |
|---|---|---|
| 0 | 0 | No Fractional Seconds Timestamp |
| 0 | 1 | Sample Count - the number of samples the radio has produced |
| | | since it started streaming (not recording). It will start at an |
| | | unknown number and rise until it overflows, where it will start |
| | | again at 0. |

3.4 Trailer

The trailer will be the last word in the packet if the T bit is set to 1. It is one 32-bit word long and is defined in section 6.1.7 of the VRT Standard document.

TABLE 13

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

| Enables (20-31) | | | | | | | State and Event Indicators (8-19) | | | | | | |
|---|---|---|---|---|---|---|---|---|---|---|---|---|---|
| | 12 | 11 | 10 | 9 | 8 | 7 | 6 | 5 | 4 | 3 | 2 | 1 | 0 |

| | | |
|---|---|---|
| State and Event | E | Associated Packet Count (0-6) |
| Indicators (8-19) | | |

### 4 File Data—Extension Data Packet (JSON)

TABLE 14

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Header (1 Word)
WBT Radio Data(Variable)

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Header (1 Word)
WBT Radio Data(Variable)

This packet is always placed immediately before an IF Context Packet, and is padded so that it and the context packet together are the same size of an IF Data packet (4000 bytes). The Extension Data Packet is user defined.

4.1 WBT Radio Data Fields

The JSON Extension Data Packet consists of data serialized in the JSON format. The JSON format does not specify any particular order that operands must be in, so QRC reserves the right to change the ordering of fields and add additional fields at any time.

TABLE 15

| Field Name | Type | Description |
|---|---|---|
| “System Time” | String | Date and time in human readable format, in the same pattern that WBT |
| | | Filenames are automatically generated. YYYY_MM_DD_HHmmSS |
| | | where Y is year, M is month, D is day, H is hour (0 to 23), m is minutes, |
| | | S is seconds. This time is taken from the WBT system clock. An |
| | | example is “2013_09_26_013953” |
| “Recording UUID” | String | UUID String unique to the recording. If the recording spans multiple |
| | | files, all files that are part of that recording session will have the same |
| | | UUID. The UUID is in the standard UUID format specified in RFC |
| | | 4122. (8-4-4-4-12). |
| | | Example: “550e8400-e29b-41d4-a716-446655440000” |
| “File Description” | String | User description of the file. May be an empty string. |
| “Radio Selection” | String | Current radio(s) in use. Potential values are: “Radio_A”, “Radio_B”, |
| | | “Radio_AB”, and “Radio_Invalid”. Future fields are also possible, |
| | | parsers of this format will simply ignore radio configurations they are |
| | | unable to handle |
| “Unit Type” | String | Type of unit creating the file. Currently only option is “WBT” |
| “Unit Hardware Version” | String | Hardware version of unit creating the file. Currently the only WBT |
| | | model is the “100”. |
| “Unit ESN” | String | Two 4 digit numbers acting as the serial number of the unit in the format |
| | | “0000-0000”. |
| “Firmware version” | String | The version of the WBT's firmware. |
| “Radio Settings - Radio | JSON^{[Error! Reference source not found.]} | See Section 4.1.1, Radio Settings |
| A” | | |
| “Radio Settings - Radio | JSON^{[Error! Reference source not found.]} | See Section 4.1.1, Radio Settings |
| B” | | |
| “GPS Latitude” | Double | The last Latitude value sent by the GPS in degrees. −777777 if there is |
| | | no GPS data. |
| “GPS Longitude” | Double | The last Longitude value sent by the GPS in degrees. −777777 if there is |
| | | no GPS data. |
| “GPS Altitude” | Double | The last Altitude value in meters sent by the GPS. −777777 if there is no |
| | | GPS data. |
| “GPS Magnetic | Double | The last Magnetic Variation value sent by the GPS. −777777 if there is |
| Variation” | | no GPS data. |
| “GPS Fix UTC Seconds” | Int | Unix time format - number of seconds from 00:00:00 Thursday, 1 |
| | | January 1970, 0 if no GPS data |
| “GPS Fix Status” | String | Indicates the status of the Global Positioning System receiver used to |
| | | obtain location data. Potential values are: “Unknown”, “Unlock”, “2D”, |
| | | and “3D” |

### 4.1.1 Radio Settings

Each collection source (Block 102) has its settings in an object which contains the following fields. There are two fields for radio settings at this time, “Radio Settings—Radio A” and “Radio Settings—Radio B”. For a better view on the communicated data see an example of the JSON packet in the following section. It should be noted that many radio types are possible. In such an instance, the user would ignore fields/types they are not supporting.

TABLE 16

| Field Name | Type | Description |
|---|---|---|
| “Center Frequency” | Double | Center Frequency of the radio per user settings |
| “Span” | Double | Span the radio is collecting at, in MHz. |
| “Receive Offset” | Double | Offset of the radio's oscillator from the Center Frequency in MHz. (This offset |
| | | is to protect against LO mixing and other radio artifacts, and can be added to |
| | | “Center Frequency” to determine the true center frequency of the collected data. |
| “Receive Gain” | Double | Gain applied to the currently recorded data. |
| “Tuner Type” | String | Type of tuner the radio is. Currently there are 3 types, “Type A”, “Type B”, and |
| | | “Type C”. See WBT promotional materials for additional information. |
| “Tuner Range” | String | Lowest recordable frequency from the tuner to highest, separated by a dash, in |
| | | Hz. An example of a Type A tuner's range is - “68750000-2200000000”. |

These settings apply to the subsequent IF Data Packets received, until the next Extension Data Packet is received.

4.2 JSON Example

The following is an example of the JSON contained in an Extension Data Packet's JSON section—

```
{
  ″System Time″: ″2013_10_29_174546″,
  ″Recording UUID″: ″e891216e-40c1-11e3-84fd-729367a707f2″,
  ″File Description″: ″″,
  ″Radio Selection″: ″Radio_AB″,
  ″Unit Type″: ″WBT″,
  ″Unit Hardware Version″: ″100″,
  ″Unit ESN″: ″0000-0000″,
  ″Firmware Version″: ″1.2.0.12″,
  ″Radio Settings - Radio A″: {
    ″Center Frequency″: 905,
    ″Span″: 0.78125,
    ″Receive Offset″: −15,
    ″Receive Gain″: −5,
    ″Tuner Type″: ″Type A″,
    ″Tuner Range″: ″68750000 - 2200000000″
  },
  ″Radio Settings - Radio B″: {
    ″Center Frequency″: 1005,
    ″Span″: 0.78125,
    ″Receive Offset″: −15,
    ″Receive Gain″: −4,
    ″Tuner Type″: ″Type B″,
    ″Tuner Range″: ″400000000 - 4400000000″
  },
  ″GPS Latitude″: −777777,
  ″GPS Longitude″: −777777,
  ″GPS Altitude″: −777777,
  ″GPS Magnetic Variation″: −777777,
  ″GPS Fix UTC Seconds″: 0,
  ″GPS Fix Status″: ″Unknown″
}
```

5 Data Packet—IF Data Packet with Stream ID

TABLE 17

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Header (1 word)
Stream ID (1 word)
Fractional Seconds Timestamp (2 words)
IQ Data(Variable)
Trailer

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Header (1 word)
Stream ID (1 word)
Fractional Seconds Timestamp (2 words)
IQ Data(Variable)
Trailer

The data packet follows the conventions of all the common field formats and is defined in section 6.1 of the VRT Standard document^{[Error! Reference source not found.]}.

5.1 Header

Refer back to Section 2, Packet Header Information.

5.2 Stream ID

Refer back to Section 3.1, Stream Identifier.

5.3 Fractional Seconds Timestamp

Refer back to Section 2.3, TSF— TimeStamp-Fractional.

5.4 IQ Data

The main IQ data is stored as two 16 bit numbers per 32-bit word in the Q0-15 format (two's complement fixed point data format with the radix to the right of bit 15 (allowing numbers between −1 and 32767/32768).

TABLE 18

| | | | | | | | | | | | | | | | | |
|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 |

| | | |
|---|---|---|
| I Sign | I Data fractional part | Q Sign |

| | | | | | | | | | | | | | | |
|---|---|---|---|---|---|---|---|---|---|---|---|---|---|---|
| 14 | 13 | 12 | 11 | 10 | 9 | 8 | 7 | 6 | 5 | 4 | 3 | 2 | 1 | 0 |

Q Data Fractional Part

5.5 Trailer Information

The IF Data Packets produced by the WBT always has a trailer value of 0x00100000 (or 1048576 in integer notation).

GPS/Radio Data—IF Context Packet

The IF Context packet is only relevant to the stream (see section 3.1) it is part of while the WBT Extension Data Packet is relevant for all streams in the file. In the same time the IF Context Packet shares much of the data it contains with the Extension Data Packet.

TABLE 19

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Header (1 word)
Stream ID (1 word)
Fractional Seconds Timestamp (2 words)
Context Section(Variable)

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Header (1 word)
Stream ID (1 word)
Fractional Seconds Timestamp (2 words)
Context Section(Variable)

5.6 Header

Refer back to Section 2, Packet Header Information.

5.7 Stream ID

Refer back to Section 3.1, Stream Identifier.

5.8 Fractional Seconds Timestamp

Refer back to Section 2.3, TSF— TimeStamp-Fractional.

5.9 Context Section

The IF Context Packet follows the conventions of all the common field formats. WBT uses the fields below.

TABLE 20

| Bit | |
|---|---|
| Position | Context Indicator Field |
| 31 | Context Field Change Indicator |
| 30 | Reference Point Identifier |
| 29 | Bandwidth |
| 28 | Unused by WBT |
| 27 | RF Reference Frequency |
| 26-25 | Unused by WBT |
| 24 | Reference Level |
| 23 | Gain |
| 22 | Unused by WBT |
| 21 | Sample Rate |
| 20 | Unused by WBT |
| 19 | Timestamp Calibration Time |
| 18-15 | Unused by WBT |
| 14 | Formatted GPS Geolocation |
| 13-0 | Unused by WBT |

When a field has its bit set to 1 it will be included in the context section. The ordering of fields is from the most significant to least significant bits in the context header.

### 5.9.1 Context Data Fields

TABLE 21

| | Field Length | |
|---|---|---|
| Field Name | in 32 bit words | Description |
| Context Field | 0 words | The Context Field Change Indicator shows whether or not the |
| Change Indicator | | information in this packet has changed since the last IF Context |
| | | Packet for its radio. It doesn't have a data field associated with it. |
| Reference Point | 1 word | The Reference Point Identifier field holds the Stream ID of the point |
| Identifier | | in time that the context packet refers to. For the WBT it should be the |
| | | same as the Stream ID for the context packet. |
| Bandwidth | 2 words | The Bandwidth field represents the amount of usable bandwidth in Hz |
| | | at the end of data processing. |
| | | This field uses the Common VITA-49.0 64 Bit Fractional Number |
| | | Format. |
| RF Reference | 2 words | The RF Reference Frequency represents the center frequency for the |
| Frequency | | WBT. |
| | | This field uses the Common VITA-49.0 64 Bit Fractional Number |
| | | Format. |
| Reference Level | 1 word | The Reference Level field indicates the signal amplitude (dBm) in the |
| | | current data stream. |
| | | It uses the format in 5.9.1.1. |
| Gain | 1 word | The Gain field uses two 16 bit two's-complement signed fractional |
| | | numbers to display the gain of the system. The Stage 1 Gain is gain |
| | | for RF, and the Stage 2 gain is the gain for IF. It uses the format in |
| | | 5.9.1.2. |
| Sample Rate | 2 words | The Sample Rate field lists the sampling rate of packets in the data |
| | | packets. It is measured in Hz. |
| | | This field uses the Common VITA-49.0 64 Bit Fractional Number |
| | | Format. |
| Timestamp | 1 word | The Timestamp Calibration Time field lists the time when the |
| Calibration Time | | recorded location data was last known to be good. It uses the same |
| | | format as the TSI field for this packet. |
| Formatted GPS | 11 words | Contains latest GPS Data. See section 5.9.1.3 |
| Geolocation | | |

### 5.9.1.1 Reference Level

TABLE 22

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

| Unused | | | | | | | | | | | Integer Part | | |
|---|---|---|---|---|---|---|---|---|---|---|---|---|---|
| | 12 | 11 | 10 | 9 | 8 | 7 | 6 | 5 | 4 | 3 | 2 | 1 | 0 |

| | |
|---|---|
| Integer Part | Fractional Part |

### 5.9.1.2 Gain

TABLE 23

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

| Stage 2 Gain Integer Part | | | | Stage 2 Gain Fractional Part | | | | | | | Stage 1 | | |
|---|---|---|---|---|---|---|---|---|---|---|---|---|---|
| | | | | | | | | | | | Gain | | |
| | | | | | | | | | | | Integer | | |
| | | | | | | | | | | | Part | | |
| | 12 | 11 | 10 | 9 | 8 | 7 | 6 | 5 | 4 | 3 | 2 | 1 | 0 |

| | |
|---|---|
| Stage 1 Gain Integer | Stage 1 Gain Fractional Part |
| Part | |

### 5.9.1.3 Formatted GPS Geolocation

The Formatted GPS Geolocation field is in the format of a packet itself.

TABLE 24

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

| | | | |
|---|---|---|---|
| Unused (28-31) | TSI | TSF | GPS/INS Manufacturer OUI (0-23) |

Integer-second Timestamp of Position Fix
Fractional Second Timestamp of Position Fix 1
Fractional Second Timestamp of Position Fix 2

| | |
|---|---|
| Latitude Integer Part (22-31) | Latitude Fractional Part (0-21) |
| Longitude Integer Part (22-31) | Longitude Fractional Part (0-21) |

Altitude Integer Part (5-31)

| Speed Over Ground Integer Part (16-31) | | | | | | | | | | | Speed | | |
|---|---|---|---|---|---|---|---|---|---|---|---|---|---|
| | | | | | | | | | | | Over | | |
| | | | | | | | | | | | Ground | | |
| | | | | | | | | | | | Fractional | | |
| | | | | | | | | | | | Part (0-15) | | |
| Heading Angle Integer Part (22-31) | | | | | Heading Angle Fractional Part (0-21) | | | | | | | | |
| Track Angle Integer Part (22-31) | | | | | Track Angle Fractional Part (0-21) | | | | | | | | |
| Magnetic Variation Integer Part (22-31) | | | | | Magnetic Variation Fractional Part (0-21) | | | | | | | | |
| | 12 | 11 | 10 | 9 | 8 | 7 | 6 | 5 | 4 | 3 | 2 | 1 | 0 |

| GPS/INS Manufacturer OUI (0-23) | |
|---|---|
| Integer-second Timestamp of Position Fix | |
| Fractional Second Timestamp of Position Fix 1 | |
| Fractional Second Timestamp of Position Fix 2 | |
| Latitude Integer Part (22-31) | |
| Longitude Integer Part (22-31) | |
| Altitude Integer Part (5-31) | Alt, Fractional (0-4) |

Speed Over Ground Fractional Part (0-15)
Heading Angle Fractional Part (0-21)
Track Angle Fractional Part (0-21)
Magnetic Variation Fractional Part (0-21)

All fields will be set to 0x7FFFFFFF when unspecified/unused unless otherwise noted.

TABLE 25

| | Field Length | |
|---|---|---|
| | in 32 bit | |
| Field Name | words | Description |
| GPS Geolocation | 1 word | The TSI and TSF fields behave as usual with regards to the |
| Header | | timestamp fields, except that if the entry is 00 then the |
| | | associated timestamp field will be set to all 1 s. The OUI is |
| | | the GPS' Organizationally Unique ID and can safely be |
| | | ignored. |
| Integer Second | 1 word | Follows the same format as section 3.2, apart from being set |
| Timestamp of Position | | to maximum value when TSI is 00. |
| Fix | | |
| Fractional Second | 2 words | Follows the same format as section 3.3, apart from being set |
| Timestamp of Position | | to maximum value when TSI is 00. |
| Fix | | |
| Latitude | 1 word | Latitude in Degrees. Two's complement fixed point signed |
| | | field with bits 0-21 being fractional and bits 22-31 integer. |
| Longitude | 1 word | Longitude in Degrees. Two's complement fixed point |
| | | signed field with bits 0-21 being fractional and bits 22-31 |
| | | integer. |
| Altitude | 1 word | Altitude in Meters. Two's complement fixed point signed |
| | | field with bits 0-4 being fractional and bits 5-31 integer. |
| Speed Over Ground | 1 word | Speed Over Ground in Meters per Second. Two's |
| | | complement fixed point signed field with bits 0-15 being |
| | | fractional and bits 15-31 integer. |
| Heading Angle | 1 word | Orientation of unit in degrees from true North. Two's |
| | | complement fixed point signed field with bits 0-21 being |
| | | fractional and bits 22-31 integer. |
| Track Angle | 1 word | Direction of Travel of unit in degrees from true North. |
| | | Two's complement fixed point signed field with bits 0-21 |
| | | being fractional and bits 22-31 integer. |
| Magnetic Variation | 1 word | Magnetic Variation from true north in degrees −180 to 180 |
| | | where −180 is west and 180 is east. Two's complement fixed |
| | | point signed field with bits 0-21 being fractional and bits |
| | | 22-31 integer. |

### 6 Future Spec—Extension Context Packet

In additional versions of the WBT software, Extension Context Packets may be used. The general format (Without content) is defined. In the event that earlier implementations are being used by any particular user, this later packet type may simply be ignored.

TABLE 26

| | | | | | | | | | | | | | | | | | | |
|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 |

Header (1 word)
Stream ID (1 word)
Integer Seconds Timestamp (1 word) (optional)
Fractional Seconds Timestamp (2 words) (optional)
QRC Defined Section (variable)

| | | | | | | | | | | | | |
|---|---|---|---|---|---|---|---|---|---|---|---|---|
| 12 | 11 | 10 | 9 | 8 | 7 | 6 | 5 | 4 | 3 | 2 | 1 | 0 |

Header (1 word)
Stream ID (1 word)
Integer Seconds Timestamp (1 word) (optional)
Fractional Seconds Timestamp (2 words) (optional)
QRC Defined Section (variable)

6.1 Header

Refer back to Section 2, Packet Header Information.

6.2 Stream ID

Refer back to Section 3.1, Stream Identifier.

6.1 Integer Seconds Timestamp

Refer back to Section 2.2, TSI—TimeStamp-Integer.

6.2 Fractional Seconds Timestamp

Refer back to Section 2.3, TSF—TimeStamp-Fractional.

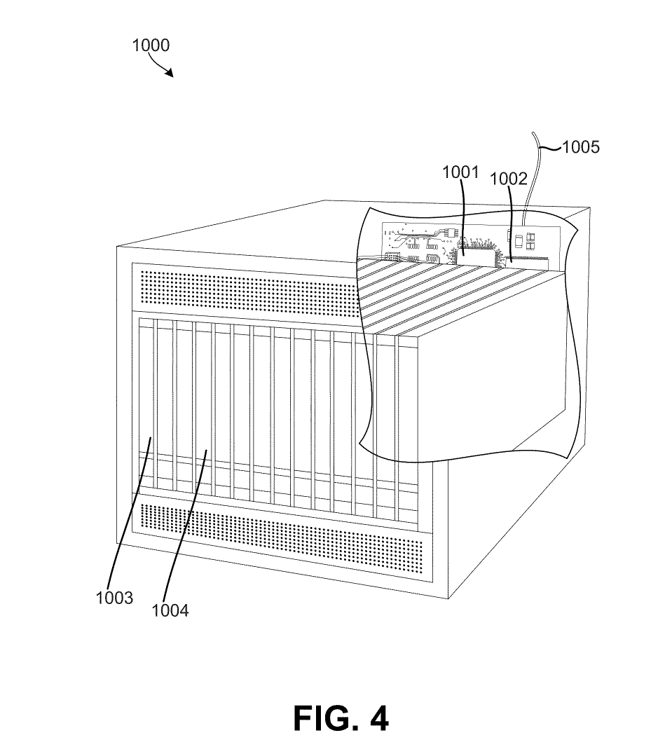

The various network components, severs, and systems may be implemented on any of a variety of commercially available server devices, such as the server 1000 illustrated in FIG. 4. Such a server 1000 typically includes a processor 1001 coupled to volatile memory 1002 and a large capacity nonvolatile memory, such as a disk drive 1003. The server 1000 may also include a floppy disc drive, compact disc (CD) or DVD disc drive 1004 coupled to the processor 1001. The server 1000 may also include network access ports 1006 coupled to the processor 1001 for establishing data connections with a network 1005, such as a local area network coupled to other computers, servers, or components in a service provider network.

The processor 1001 may be any programmable microprocessor, microcomputer or multiple processor chip or chips that can be configured by software instructions (applications) to perform a variety of functions, including the functions of the various embodiments described above. In some mobile receiver devices, multiple processors may be provided, such as one processor dedicated to wireless communication functions, one processor dedicated to video processing, and one processor dedicated to running other applications. Typically, software applications may be stored in the internal memory 1002 before they are accessed and loaded into the processor 1001. The processor 1001 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as hardware, software, or any combination thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

Embodiments implemented in computer software may be implemented in software, firmware, middleware, microcode, hardware description languages, or any combination thereof. A code segment or machine-executable instructions may represent a procedure, a function, a subprogram, a program, a process, a task, a tread, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a signal processing circuit that may be suitable for use in a wireless receiver or mobile device. Such a wireless signal processing circuit may include circuits for accomplishing the signal measuring and calculating steps described in the various embodiments.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for receiving, storing, manipulating and distributing RF data, the method comprising:
receiving by a computing device first collected RF data;
storing by the computing device the first collected RF data in a storage device;
receiving by the computing device a request for the first collected RF data, wherein the request comprises one or more modification parameters;
selecting by the computing device one or more processing algorithms based on the one or more modification parameters;
applying by the computing device the selected one or more processing algorithms to the first collected RF data; and
providing by the computing device the manipulated RF data in response to the request.

2. The method of claim 1, wherein the modification parameters are selected from the group consisting of a filter specification, a noise type, and a multipath specification.

3. The method of claim 1, wherein the processing algorithms are selected from the group consisting of a frequency shifting, selection of bandwidth, application of a specific filter type, decimating, duration subsets (different start and/or end point), sample counts, noise addition/subtraction, a multi-path simulation, a power level adjustments, and an output format translation.

4. The method of claim 1, wherein providing by the computing device the manipulated RF data in response to the request comprises providing by the computing device the manipulated RF data via a network.

5. The method of claim 1, wherein providing by the computing device the manipulated RF data in response to the request comprises authorizing by the computing device the delivery of the manipulated RF data on a tangible medium.

6. The method of claim 1, wherein providing by the computing device the manipulated RF data in response to the request comprises providing by the computing device the manipulated RF data for a fee.

7. The method of claim 1 further comprising:
storing by the computing device the manipulated RF data in the storage device;
receiving by the computing device a request for the manipulated RF data, wherein the request comprises one or more modification parameters;
selecting by the computing device one or more processing algorithms based on the one or more modification parameters;
applying by the computing device the selected one or more processing algorithms to the manipulated RF data; and
providing by the computing device the twice manipulated RF data in response to the request.

8. A method for manipulating RF data, the method comprising:
receiving by a computing device first and second collected RF data;
storing by the computing device the first and second collected RF data in a storage device;
receiving by the computing device a request for the first collected RF data, wherein the request comprises one or more modification parameters and wherein at least one of the modification parameters is combining the first collected data with the second collected data;
selecting by the computing device one or more processing algorithms based on the one or more modification parameters;
applying by the computing device the selected one or more processing algorithms to the first collected RF data and the second collected RF data; and
providing by the computing device the manipulated RF data in response to the request.

9. The method of claim 8, wherein the modification parameters are selected from the group consisting of a filter specification, a noise type, and a multipath specification.

10. The method of claim 8, wherein the processing algorithms are selected from the group consisting of a frequency shifting, selection of bandwidth, application of a specific filter type, decimating, duration subsets (different start and/or end point), sample counts, noise addition/subtraction, a multi-path simulation, a power level adjustments, and an output format translation.

11. The method of claim 8, wherein providing by the computing device the manipulated RF data in response to the request comprises providing by the computing device the manipulated RF data via a network.

12. The method of claim 8, wherein providing by the computing device the manipulated RF data in response to the request comprises authorizing by the computing device the delivery of the manipulated RF data on a tangible medium.

13. The method of claim 8, wherein providing by the computing device the manipulated RF data in response to the request comprises providing by the computing device the manipulated RF data for a fee.

14. The method of claim 8 further comprising:
storing by the computing device the manipulated RF data in the storage device;
receiving by the computing device a request for the manipulated RF data, wherein the request comprises one or more modification parameters;
selecting by the computing device one or more processing algorithms based on the one or more modification parameters;
applying by the computing device the selected one or more processing algorithms to the manipulated RF data; and
providing by the computing device the twice manipulated RF data in response to the request.
